(19) United States
(12) Patent Application Publication
(10) Pub. No.: US 2008/0001487 A1
(43) Pub. Date: Jan. 3, 2008

(54) Closed-type motor having a cooling tube

(75) Inventors: Yi-Tang Wei, Nantou (TW); Chia-Wen Ruan, Nantou (TW)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: JOY RIDE TECH. CO., LTD.

(21) Appl. No.: 11/543,828

(22) Filed: Oct. 6, 2006

(30) Foreign Application Priority Data
Jul. 3, 2006 (TW) 095124117

(51) Int. Cl. H02K 9/00; H02K 9/20; B60K 1/00

(52) U.S. Cl. 310/54; 310/52; 310/83; 310/67 R; 180/65.5

(57) ABSTRACT

A closed-type motor includes a casing defining a chamber, a stator fixed in the chamber, a rotor mounted in the chamber and rotatable relative to the stator, and a cooling tube having inlet and outlet ends, and an intermediate portion interconnecting the inlet and outlet ends and located within the chamber. The inlet end extends out of the casing, and is adapted for entry of a cooling fluid. The outlet end extends out of the casing, and is adapted for exit of the cooling fluid that flows through the intermediate portion.

### CROSS-REFERENCE TO RELATED APPLICATION

This application claims priority of Taiwanese Application No. 095124117, filed on Jul. 3, 2006.

### BACKGROUND OF THE INVENTION

1. Field of the Invention

The invention relates to a closed-type motor, more particularly to a closed-type motor that has a cooling tube.

2. Description of the Related Art

A conventional closed-type motor, also known as an in-wheel motor, generally has a casing, and a stator and a rotor mounted respectively in the casing. One end of the rotor can activate a wheel hub through a drive device, such as a planetary gear, and the wheel hub, in turn, can bring a rear wheel to rotate therealong.

Since an electronic circuit is provided inside the casing of the motor, and since it is desirable to protect elements of the motor and the electronic circuit from exposure to dust, the casing of the motor is designed in a closed configuration. However, as the temperature rises due to rotation of the rotor, heat inside the casing increases while only being minimally dissipated therefrom. This adversely affects the operating efficiency of the motor.

### SUMMARY OF THE INVENTION

Therefore, the object of the present invention is to provide a closed-type motor that has a cooling tube and that is capable of overcoming the aforementioned drawback of the prior art.

According to this invention, a closed-type motor comprises a casing defining a chamber, a stator fixed in the chamber, a rotor mounted in the chamber and rotatable relative to the stator, and a cooling tube. The rotor has an output portion extending out of the casing. The cooling tube has an inlet end, an outlet end, and an intermediate portion interconnecting the inlet and outlet ends. The inlet end extends out of the casing, and is adapted for entry of a cooling fluid. The intermediate portion is located within the chamber. The outlet end extends out of the casing, and is adapted for exit of the cooling fluid that flows through the intermediate portion.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled sectional view of a wheel hub drive device and the preferred embodiment of a closed-type motor according to the present invention; and

FIG. 2 is a perspective view of a cooling tube of the preferred embodiment.

### DETAILED DESCRIPTION OF THE PREFERRED EMBODIMENT

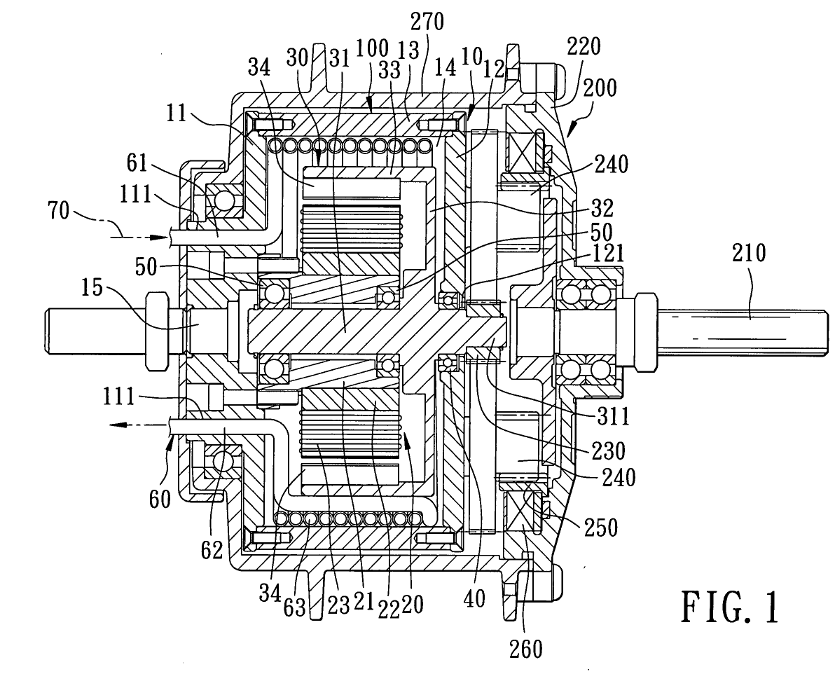

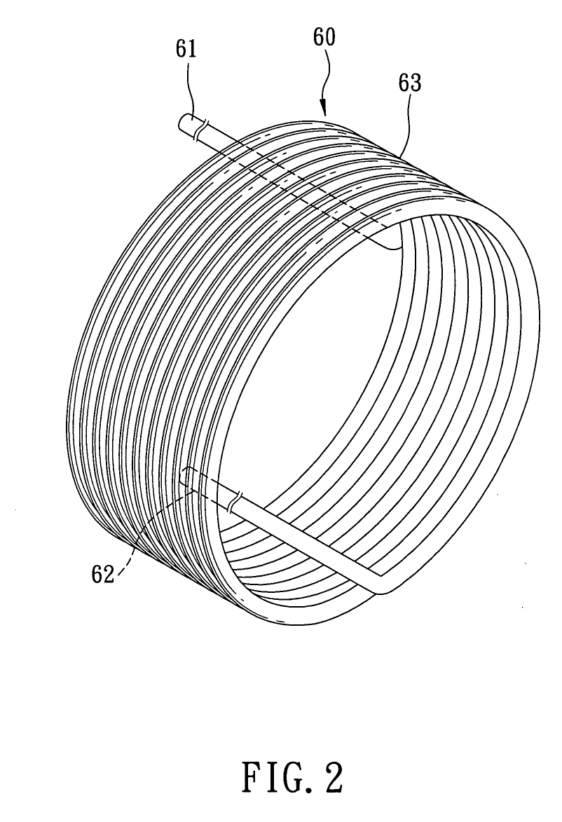

Referring to FIGS. 1 and 2, the preferred embodiment of a closed-type motor 100 according to the present invention is shown to comprise a casing 10, a stator 20, a rotor 30, a first bearing 40, two second bearings 50, and a cooling tube 60.

The casing 10 has a first end wall 11, a second end wall 12 opposite to the first end wall 11, a surrounding wall 13 interconnecting the first and second end walls 11, 12, a chamber 14 defined by the first and second end walls 11, 12 and the surrounding wall 13, and a shaft 15 extending outwardly of the casing 10 from the first end wall 11. The first end wall 11 has two through holes 111, while the second end wall 12 has one through hole 121.

The stator 20 is fixed in the chamber 14, and has a tubular sleeve 21 fixed to the first end wall 11, a coil-accommodating member 22 sleeved on the tubular sleeve 21, and a plurality of coils 23 wrapped around the coil-accommodating member 22.

The rotor 30 is mounted in the chamber 14, and is rotatable relative to the stator 20. The rotor 30 has a rotor shaft 31 disposed rotatably in the tubular sleeve 21 and connected to the second end wall 12, an end plate 32 extending outwardly and radially from the rotor shaft 31, an annular wall 33 extending axially from a peripheral end of the end plate 32 and surrounding the stator 20, and a plurality of magnets 34 provided on an inner wall face of the annular wall 33. The rotor shaft 31 has an output portion 311 extending outwardly of the casing 10 via the through hole 121.

The first bearing 40 is disposed between the second end wall 12 and the rotor shaft 31.

The second bearings 50 are mounted between the tubular sleeve 21 and the rotor shaft 31 in a spaced apart manner.

The cooling tube 60, as best shown in FIG. 2, has an inlet end 61, an outlet end 62, and an intermediate portion 63 interconnecting the input and outlet ends 61, 62. The inlet end 61 extends out of the casing 10 via one of the through holes 111, and is adapted for entry of a cooling fluid 70. The intermediate portion 63 is located within the chamber 14, and is coiled around the stator 20 and the rotor 30. More specifically, the intermediate portion 63 is coiled around the annular wall 33 of the rotor 30 within the surrounding wall 13 of the casing 10. The outlet end 62 extends out of the casing 10 via the other one of the through holes 111, and is adapted for exit of the cooling fluid 70 that flows through the intermediate portion 63. In this embodiment, the cooling fluid 70 is cold air. Alternatively, the cooling fluid 70 may be a cold liquid substance.

With reference to FIG. 1, the closed-type motor 100 of the present invention can be used in combination with a wheel hub drive device 200. The wheel hub drive device 200 includes a hub carrier 270 that forms a housing for the motor 100, a spindle 210 connected to the hub carrier 270, a wheel hub 220 supported rotatably on the hub carrier 270 through the spindle 210, a first gear 230 disposed on the output portion 311 of the rotor shaft 31, a plurality of second gears 240 mounted rotatably on the second end wall 12, a ring gear 250 connected to the wheel hub 220, and a one-way clutch 260 mounted between the ring gear 250 and the wheel hub 220.

When the rotor 30 rotates relative to the stator 20, the rotor 30 rotates the wheel hub 220 through the first gear 230, the second gears 240, the ring gear 250, and the one-way clutch 260. During such rotation, the cooling fluid 70 enters the casing 10 through the inlet end 61 of the cooling tube 60, flows through the intermediate portion 63 of the cooling tube 60, absorbs the heat produced by the rotor 30 and the stator 20, and exits through the outlet end 62 of the cooling tube 60, thereby discharging the absorbed heat from the motor 100. Hence, the temperature in the casing 10 is effectively reduced, and the operating efficiency of the rotor 30 and the stator 20 is maintained.

From the aforementioned description, the advantages of the present invention can be summarized as follows:

Through use of the cooling mechanism provided in the motor 100, that is, flow of the cooling fluid 70 through the intermediate portion 63 of the cooling tube 60 that surrounds the rotor 30 and the stator 20 so as to absorb and discharge the heat produced by the rotor 30 and the stator 20, the temperature inside the casing 10 can be effectively reduced. In comparison with the conventional closed-type motor, the motor 100 of the present invention not only can prevent dust from entering the casing 10, but can also maintain a high level of operating efficiency even after long hours of operation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A closed-type motor comprising:
a casing defining a chamber;
a stator fixed in said chamber;
a rotor mounted in said chamber and rotatable relative to said stator, said rotor having an output portion extending out of said casing; and
a cooling tube having an inlet end, an outlet end, and an intermediate portion interconnecting said inlet and outlet ends, said inlet end extending out of said casing and being adapted for entry of a cooling fluid, said intermediate portion being located within said chamber, said outlet end extending out of said casing and being adapted for exit of the cooling fluid that flows through said intermediate portion.

2. The closed-type motor of claim 1, wherein said casing has a first end wall, a second end wall opposite to said first end wall, a surrounding wall interconnecting said first and second end walls, and a shaft extending outwardly of said casing from said first end wall, said first and second end walls and said surrounding wall cooperatively defining said chamber, said first end wall having two through holes to permit said input and output ends to extend outward therethrough respectively, said second end wall having a through hole for outward extension of said output portion of said rotor therethrough.

3. The closed-type motor of claim 2, wherein said stator has a tubular sleeve fixed to said first end wall, a coil-accommodating member sleeved on said tubular sleeve, and a plurality of coils wrapped around said coil-accommodating member, said rotor further having a rotor shaft disposed rotatably in said tubular sleeve and connected to said second end wall, an end plate extending outwardly and radially from said rotor shaft, an annular wall extending axially from a peripheral end of said end plate and surrounding said stator, and a plurality of magnets provided on an inner wall face of said annular wall, said output portion being formed on one end of said rotor shaft.

4. The closed-type motor of claim 1, wherein said intermediate portion of said cooling tube is coiled around said stator and said rotor.

5. The closed-type motor of claim 3, wherein said intermediate portion of said cooling tube is coiled around said annular wall within said surrounding wall.

6. The closed-type motor of claim 3, further comprising a first bearing disposed between said second end wall and said rotor shaft, and two spaced-apart second bearings mounted between said tubular sleeve and said rotor shaft.
